(19) United States
(12) Patent Application Publication
(10) Pub. No.: US 2016/0059693 A1
(43) Pub. Date: Mar. 3, 2016

(54) FUEL SUPPLY DEVICE

(71) Applicant: AISAN KOGYO KABUSHIKI KAISHA, Aichi-ken (JP)

(72) Inventor: Masaki Ikeya, Aichi-ken (JP)

(73) Assignee: AISAN KOGYO KABUSHIKI KAISHA, Aichi-ken (JP)

(21) Appl. No.: 14/938,556

(22) Filed: Nov. 11, 2015

Related U.S. Application Data
(63) Continuation of application No. 13/845,402, filed on Mar. 18, 2013.

(30) Foreign Application Priority Data
Mar. 30, 2012 (JP) 2012-081500

(51) Int. Cl. B60K 15/04

(52) U.S. Cl. CPC B60K 15/04

(57) ABSTRACT

A fuel supply device is provided. The fuel supply device includes a set plate closing an opening of a fuel tank. A housing is disposed on an opposite side of the fuel tank with respect to the set plate and stores an electric circuit. A connector is disposed on the opposite side of fuel tank with respect to the set plate, and between the set plate and the housing, connecting the set plate and the housing. An air passage is disposed between the set plate and the housing, and communicates with atmosphere. The set plate, the housing and the connector are provided integrally.

### CROSS-REFERENCE TO RELATED APPLICATION

This application is a continuation of U.S. patent application Ser. No. 13/845,402, “FUEL SUPPLY DEVICE” filed on Mar. 18, 2013, which claims priority to Japanese Patent Application No. 2012-081500 filed on Mar. 30, 2012, both of which are hereby incorporated by reference into the present application.

### TECHNICAL FIELD

The technique disclosed in the present description relates to a fuel supply device.

### DESCRIPTION OF RELATED ART

Japanese Patent Application Publication No. 2008-215339 discloses a fuel supply device that is provided with a set plate having a case body that stores an electronic circuit and a fuel storage chamber that stores fuel for cooling the electronic circuit. The case body and the cooling fuel storage chamber are separated by a housing, and the electronic circuit is cooled by the fuel with the housing interposed.

### SUMMARY

In Japanese Patent Application Publication No. 2008-215339, since the electronic circuit is cooled by the fuel with the housing interposed, the efficiency of cooling the electronic circuit depends on the thermal conductivity of the housing. The present description provides a fuel supply device that has a favorable efficiency of cooling the electronic circuit.

The present description discloses a technique related to a fuel supply device. The fuel supply device includes a fuel pump configured to supply fuel from a fuel tank to an outside; a set plate set on an opening of the fuel tank and including a fuel chamber in which the fuel is stored; a fuel supply passage configured to supply the fuel chamber with a part of the fuel from the fuel pump; and a first electronic circuit disposed on the set plate. An outlet configured to discharge the fuel from the fuel chamber to the fuel tank is formed in the fuel chamber. A part of the first electronic circuit is exposed in the fuel chamber of the set plate.

In the fuel supply device, the first electronic circuit is exposed in the fuel chamber in which fuel for cooling the first electronic circuit circulates. The fuel flows in direct contact with the first electronic circuit to cool the first electronic circuit. Thus, high efficiency of cooling the first electronic circuit can be obtained regardless of the thermal conductivity of members such as a housing.

### BRIEF DESCRIPTION OF DRAWINGS

FIG. 1 is a longitudinal cross-sectional view of a fuel supply device according to a first embodiment.

FIG. 2 is an enlarged view near a first and a second electronic circuit of the fuel supply device shown in FIG. 1.

FIG. 3 is a cross-sectional view along line III-III of FIG. 2.

FIG. 4 is a cross-sectional view along line IV-IV of FIG. 2.

FIG. 5 is a view showing a fuel flowing direction in FIG. 2.

FIG. 6 is a view showing near a first and a second electronic circuit of a fuel supply device according to a second embodiment.

FIG. 7 is a cross-sectional view along line VII-VII of FIG. 6.

FIG. 8 is a view showing near a first and a second electronic circuit of a fuel supply device according to a third embodiment.

FIG. 9 is a cross-sectional view along line IX-IX of FIG. 8.

FIG. 10 is a view showing near a first and a second electronic circuit of a fuel supply device according to a fourth embodiment.

FIG. 11 is a cross-sectional view along line XI-XI of FIG. 10.

FIG. 12 is a plan view of a body and a second casing according to a modification.

FIG. 13 is a perspective view showing a first and a second casing according to a modification.

FIG. 14 is a plan view of a body, a second casing, and the like according to a modification.

FIG. 15 is a view for explaining an electronic circuit provided in the second casing shown in FIG. 14.

### DETAILED DESCRIPTION OF EMBODIMENT

In a fuel supply device disclosed in the present description, a fuel supply passage may be connected to a bottom of a fuel chamber, and an outlet may be adjacent to the fuel supply passage. Since fuel flowing from the outlet is delivered into a fuel tank along the adjacent fuel supply passage, the sound of the fuel falling in the fuel tank is reduced, and the fuel is reliably delivered into the reserve cup.

The fuel supply device disclosed in the present description may further include a controller configured to control an amount of fuel supplied from the fuel supply passage in accordance with a calorific value of a first electronic circuit. Control of increasing an amount of fuel supplied when the first electronic circuit generates heat can be performed, for example.

The fuel supply device disclosed in the present description may further include a second electronic circuit electrically connected to the first electronic circuit. The set plate may include a body including a first casing configured to store the first electronic circuit, a second casing configured to store the second electronic circuit, and a lid attached at an opening of the first casing. The fuel chamber may be formed in at least a part of the first casing, the second casing may be positioned above the first casing, and the second casing and the lid may be integrally formed with resin. In this case, an air passage communicating with atmosphere is preferably formed between an upper surface of the lid and a lower surface of the second casing. When the lid attached at the opening of the first casing is formed with resin, fuel may permeate through the resin. Since the fuel permeating through the lid from the inside of the first casing is discharged to the atmosphere that passes through the air passage, the fuel can be suppressed from permeating into the second casing in which the second electronic circuit vulnerable to fuel is stored. The air passage may serve as an inserting portion in which a fixing member configured to fix the second casing and the body is to be inserted. Heat generated by the first electronic circuit is prevented from being transmitted to the second electronic circuit.

In the fuel supply device disclosed in the present description, the second casing and a connector may be formed inside of a circumference of the body. For example, when the circumference of the body is circular in a plan view, the upper and lower surfaces of the second casing may have the shape of a fan having an arc portion that follows the circumference of the body. Thus, the second casing can be disposed without protruding from the circumference of the body.

In the fuel supply device disclosed in the present description, the first electronic circuit may be a pump controller configured to operate the fuel pump. The pump controller is likely to generate heat and can be efficiently cooled by disposing the same in direct contact with fuel. Further, the first electronic circuit and may be a capacitance sensor configured to detect a property of the fuel. Since the pump controller is in direct contact with the stirred fuel supplied from the fuel pump, the property of the fuel can be measured with high accuracy.

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved fuel supply devices.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### First Embodiment

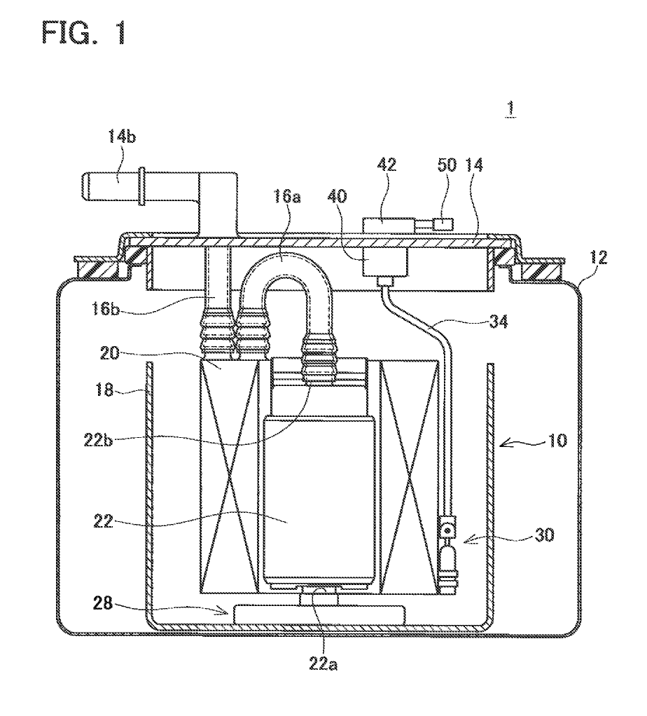

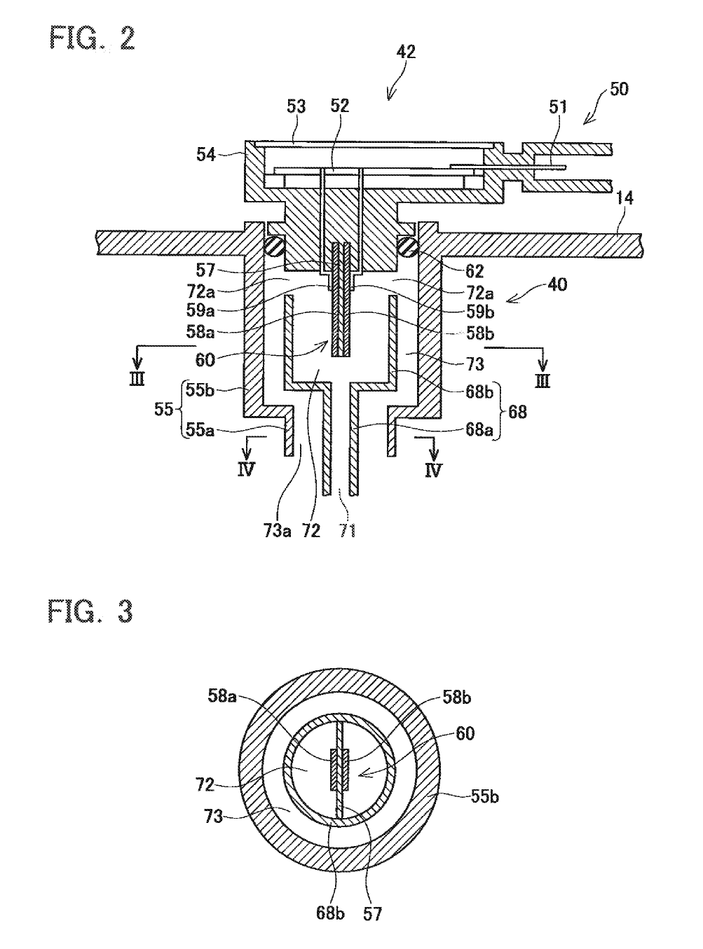

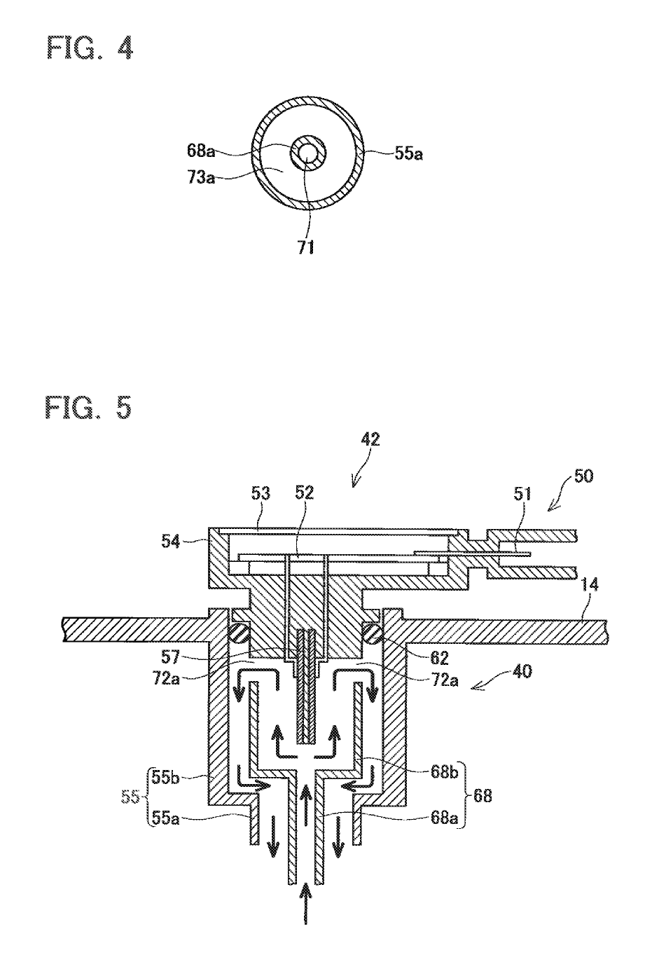

A first embodiment that embodies the present invention will be described with reference to FIGS. 1 to 5. A fuel supply device 1 according to this embodiment is attached to an automobile or the like and is used for supplying fuel to an engine. As shown in FIG. 1, the fuel supply device 1 includes a lid-shaped body 14 set on a fuel tank 12 and a fuel pump 22 stored in the fuel tank 12. A fuel extracting pipe 14b is formed on an upper surface of the body 14. The fuel extracting pipe 14b is connected to one end of a fuel supply pipe (not shown). The other end of the fuel supply pipe is connected to the engine. The body 14 is circular in a plan view and is attached at an opening of the fuel tank 12.

A fuel supply portion 10 includes a reserve cup 18, a fuel pump 22, a fuel filter 20, a suction filter 28, and a pressure regulator 30. The reserve cup 18 is approximately cylindrical and has an open upper end and a bottom. The reserve cup 18 stores the fuel pump 22, the fuel filter 20, the suction filter 28, and the pressure regulator 30 and is disposed at the bottom of the fuel tank 12. The suction filter 28 is formed at the bottom of the reserve cup 18 and is positioned under the fuel pump 22. The pressure regulator 30 is formed at the bottom of the reserve cup 18. A first casing 40 of the body 14 and the pressure regulator 30 are connected by a pipe line 34.

The fuel pump 22 is stored in the reserve cup 18 so that an axial line thereof is vertical to the opening of the fuel tank 12 and a fuel discharge port 22b is on the upper side and the fuel sucking port 22a is on the lower side. The fuel discharge port 22b is connected to the fuel filter 20 via a connection pipe 16a. The fuel filter 20 is approximately cylindrical and is arranged around the fuel pump 22. The fuel filter 20 is connected to the fuel extracting pipe 14b via a connection pipe 16b. Moreover, the fuel filter 20 is connected to the pressure regulator 30. The pressure regulator 30 allows a part of fuel discharged from the fuel pump 22 to the fuel filter 20 to flow into a pipe line 68a to thereby regulate the pressure of the fuel flowing from the fuel filter 20 to the connection pipe 16b. In this manner, the pressure of the fuel supplied to the engine is maintained to be constant.

As shown in FIGS. 1 to 4, the first casing 40 that stores a first electronic circuit 60 is formed in the body 14. A second casing 42 that stores a second electronic circuit 52 is positioned above the body 14. A connector 50 is formed in the second casing 42. That is, the body 14 and the second casing 42 are examples of a “set plate” described in the claims.

The first casing 40 includes an outer member 55 and an inner member 68. The first casing 40 includes a fuel supply passage 71, a fuel chamber 72, and a fuel delivery passage 73 that are partitioned by the outer member 55 and the inner member 68.

The outer member 55 and the inner member 68 are disposed with a gap therebetween. The inner member 68 includes the pipe line 68a and a cylindrical container 68b having a bottom surface. The pipe line 68a has an upper end connected to the bottom surface of the container 68b and a lower end connected to the pipe line 34. The flow path inside the pipe line 68a is the fuel supply passage 71. The inside of the outer member 55 is a fuel chamber, and a circuit storage portion 72 and a fuel delivery portion 73 are partitioned by the container 68b. The inside of the container 68b is the circuit storage portion 72, and the outside of the container 68b is the fuel delivery portion 73. The entire first electronic circuit 60 is exposed to the circuit storage portion 70 of the fuel chamber. The outer member 55 includes a pipe line 55a and a cylindrical container 55b. The upper end of the container 55b is open. The pipe line 55a has an upper end connected to the bottom surface of the container 55b. The pipe line 68a is disposed inside the pipe line 55a. The pipe line 55a is sufficiently shorter than the pipe line 68a, and an outlet 73a at the lower end of the pipe line 55a is open to the inside of the reserve cup 18 in the fuel tank 12. The pipe line 68a is disposed in and near the outlet 73a, the outlet 73a and a flow path near the outlet 73a are partitioned by the outer surface of the pipe line 68a and the inner surface of the pipe line 55a. That is, the outlet 73a is adjacent to the outside of the fuel supply passage 71.

The first electronic circuit 60 is a capacitance sensor. The first electronic circuit 60 includes a planar portion 57 and a pair of electrodes 58a and 58b formed on the front and rear surfaces of the planar portion 57. The pair of electrodes 58a and 58b is a pair of electrodes formed on the front and rear surfaces so as to face each other with a gap therebetween. The pair of electrodes 58a and 58b is electrically connected to the second electronic circuit 52 by terminals 59a and 59b, respectively. Since the first electronic circuit 60 is in direct contact with the fuel flowing inside the fuel chamber 72, the property (for example, quality, ethanol content, and the like) of the fuel can be examined by examining capacitance using the first electronic circuit 60. The second electronic circuit 52 is a signal processing circuit that processes electrical signals input from the first electronic circuit 60 and outputs processed signals to an external circuit via the connector 50. Although not shown in the figure, the fuel supply device 1 includes a detector (for example, a thermistor or the like) that detects a calorific value of the first electronic circuit 60. By controlling the fuel discharged from the fuel pump 22 according to a detection value detected by the detector, the amount of fuel supplied from the pressure regulator 30 to the fuel chamber 72 can be controlled. In this manner, the amount of fuel supplied to the fuel chamber 72 is regulated according to the calorific value of the first electronic circuit 60, and the first electronic circuit 60 is appropriately cooled.

The second casing 42 includes a housing 54 and a lid 53. The second electronic circuit 52 is disposed inside the housing 54, and the housing 54 is sealed by the lid 53 formed on the upper surface of the housing 54. The second electronic circuit 52 and the connector 50 are electrically connected by a terminal 51.

The lower surface of the housing 54 is exposed to the inside of the first casing 40. The upper end of the planar portion 57 of the first electronic circuit 60 is fixed to the lower surface of the housing 54. The planar portion 57 extends downward from the lower surface of the housing 54, and a lower end thereof is positioned in the circuit storage portion 72 of the fuel chamber of the first casing 40.

The body 14 and the outer member 55 are integrally formed with resin. The housing 54, the planar portion 57, and the connector 50 are integrally formed with resin. The bottom of the housing 54 is fitted to the inside of the outer member 55. The gap between the housing 54 and the outer member 55 is sealed by a sealant 62. The bottom of the housing 54 functions as a lid that is attached at the opening of the container 55b of the first casing 60. The upper end of the container 68b of the inner member 68 excluding a portion in which the passage 72a is formed is bonded to the lower surface of the housing 54.

The operation of the fuel supply device 1 will be described. When power is supplied to the fuel pump 22 from an external power source, the fuel pump 22 operates. When the fuel pump 22 operates, the fuel in the reserve cup 18 is sucked and filtered by the suction filter 28 and is sucked into the fuel pump 22 from the fuel sucking port 22a. The fuel sucked into the fuel pump 22 is pressurized and is discharged from the fuel discharge port 22b. The fuel discharged from the fuel pump 22 is delivered to the fuel filter 20 and is filtered again. The pressure of the fuel filtered by the fuel filter 20 is regulated to appropriate pressure according to an operation state of the engine by the pressure regulator 30. The pressure-regulated fuel is delivered to the engine from the fuel extracting pipe 14b.

On the other hand, the fuel returning from the pressure regulator 30 is delivered to the fuel supply passage 71 in the pipe line 68a. FIG. 5 shows the flow of fuel flowing through the fuel supply passage 71, the circuit storage portion 72, and the fuel delivery portion 73 by arrows. The fuel delivered from the pressure regulator 30 to the fuel supply passage 71 passes through a connection portion between the pipe line 68a and the container 68b and is then delivered into the circuit storage portion 72 of the fuel chamber. The first electronic circuit 60 is disposed in the circuit storage portion 72 in an exposed state, and the first electronic circuit 60 is in contact with fuel and cooled by fuel. Since the first electronic circuit 60 is in direct contact with fuel, the first electronic circuit 60 is efficiently cooled. Since the fuel that is discharged from the fuel pump 22 and is stirred is in contact with the first electronic circuit 60, the first electronic circuit 60 can detect fuel properties with high accuracy. That is, when the fuel in the fuel tank 12 is configured to be in contact with the first electronic circuit 60 (that is, a capacitance sensor), if the fuel is separated within the fuel tank 12, the first electronic circuit 60 cannot accurately detect fuel properties. On the other hand, according to the configuration of this embodiment, since the first electronic circuit 60 is in contact with the fuel that is discharged from the fuel pump 22 and is stirred, the above problem does not occur, and the fuel properties can be detected with high accuracy. The container 68b stores an amount of fuel necessary for the first electronic circuit 60 to allow the first electronic circuit 60 to be reliably in contact with the fuel. Moreover, when the pressure regulator 30 or a check valve (not shown) formed upstream the container 68b is closed, the fuel stored in the container 68b is maintained even when the fuel pump 22 is stopped.

After that, the fuel passes through the passage 72a above the container 68b and flows into the fuel delivery portion 73 between the container 68b and the container 55b. The fuel passes through the fuel delivery portion 73 and is discharged from the outlet 73a to the fuel tank 12. Since the outlet 73a is adjacent to the outer surface of the pipe line 68a that partitions the fuel supply passage 71, the fuel reliably returns into the reserve cup 18 in the fuel tank 12 along the outer surfaces of the pipe line 68a and the pipe line 34 connected to the pipe line 68a. As shown in FIG. 1, since the pipe line 34 extends up to the pressure regulator 30 formed under the fuel tank 12, the fuel discharged from the outlet 73a can be suppressed from falling on the surface of the fuel stored in the reserve cup 18 from the outlet 73a, and the generation of the sound of the falling fuel can be suppressed.

### Second Embodiment

A fuel supply device according to a second embodiment is different from the fuel supply device according to the first embodiment in terms of the configuration of the first casing.

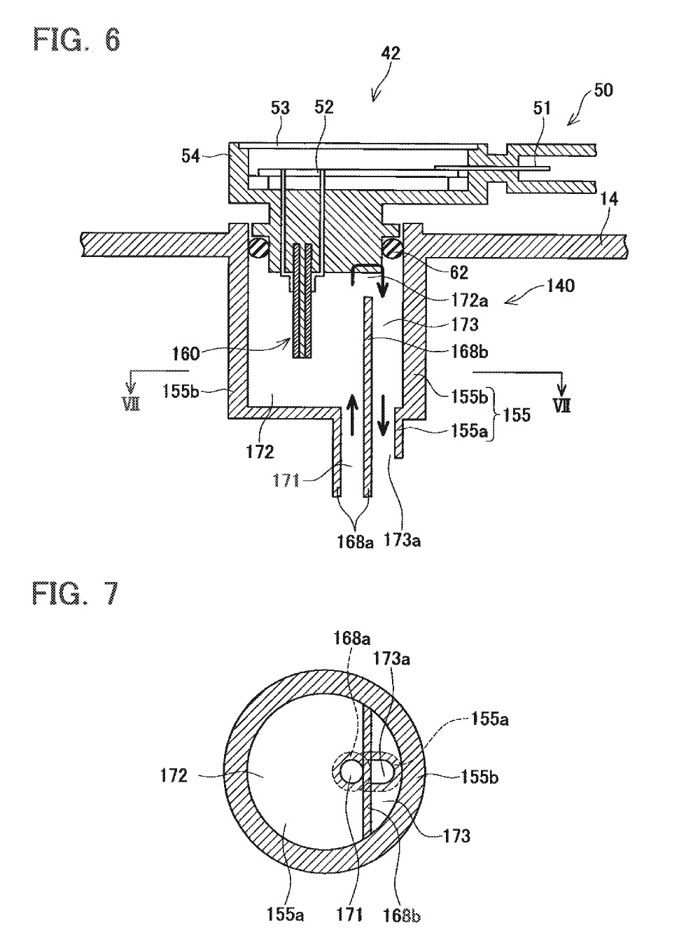

As shown in FIGS. 6 and 7, a first casing 140 includes an outer member 155, a pipe line 168a, and a planar portion 168b. The outer member 155 includes a semi-circular pipe line 155a of which the cross-section of the flow path has an approximately semi-circular shape and a cylindrical container 155b having a bottom surface. The upper end of the container 155b is open. The semi-circular pipe line 155a is bonded to a side surface of the pipe line 168a on a side where the semi-circular pipe line 155a is chipped in an approximately semi-circular shape. The upper ends of the semi-circular pipe line 155a and the pipe line 168a are connected to the bottom surface of the container 155b. The lower end of the pipe line 168a is connected to the pipe line 34. The inner flow path of the pipe line 168a is the fuel supply passage 171. The planar portion 168b is disposed at such a position that the planar portion 168b passes above the semi-circular pipe line 155a and the pipe line 168a and partitions the container 155b. The inside of the container 155b is a fuel chamber and is separated by the planar portion 168b into a circuit storage portion 172 connected to the pipe line 168a and a fuel delivery portion 173 connected to the semi-circular pipe line 155a. The circuit storage portion 172 and the fuel delivery portion 173 communicate with each other in a passage 172a that is above the planar portion 168b. The fuel delivery portion 173 is connected to an outlet 173a that is at the lower end of the semi-circular pipe line 155a. Similarly to FIG. 1, the outlet 173a is open to the inside of the reserve cup 18 in the fuel tank 12. The outlet 173a and the vicinity thereof are formed of the inner surface of the semi-circular pipe line 155a and a part of the outer surface of the pipe line 168a and are adjacent to a part of the outer surface of the fuel supply passage 171.

The body 14, the outer member 155, the pipe line 168a, and the planar portion 168b are integrally formed with resin. The housing 54 and the connector 50 are integrally formed with resin.

A first electronic circuit 160 is disposed in the circuit storage portion 172 in an exposed state. Since the specific configuration of the first electronic circuit 160 is the same as the first electronic circuit 60, detailed description thereof will not be provided. Since the other configuration of the fuel supply device according to the second embodiment is the same as the first embodiment, description thereof will not be provided.

According to the second embodiment, the same operational effects as the first embodiment can be obtained. That is, since the first electronic circuit 160 is exposed to the inside of the circuit storage portion 172 of the fuel chamber and is in direct contact with fuel, the first electronic circuit 160 is efficiently cooled. Moreover, the outlet 173a is adjacent to a part of the outer surface of the pipe line 168a that partitions the fuel supply passage 171. Thus, the fuel reliably returns into the reserve cup 18 in the fuel tank 12 along the outer surfaces of the pipe line 168a and the pipe line 34, and the generation of the sound of the fuel falling when the fuel is delivered can be suppressed. Further, since the first electronic circuit 160 is in contact with the fuel that is discharged from the fuel pump 22 and is stirred, the first electronic circuit 160 can detect fuel properties with high accuracy.

### Third Embodiment

A fuel supply device according to a third embodiment is different from the fuel supply device according to the first embodiment in terms of the configuration of the first and second casings and the first electronic circuit.

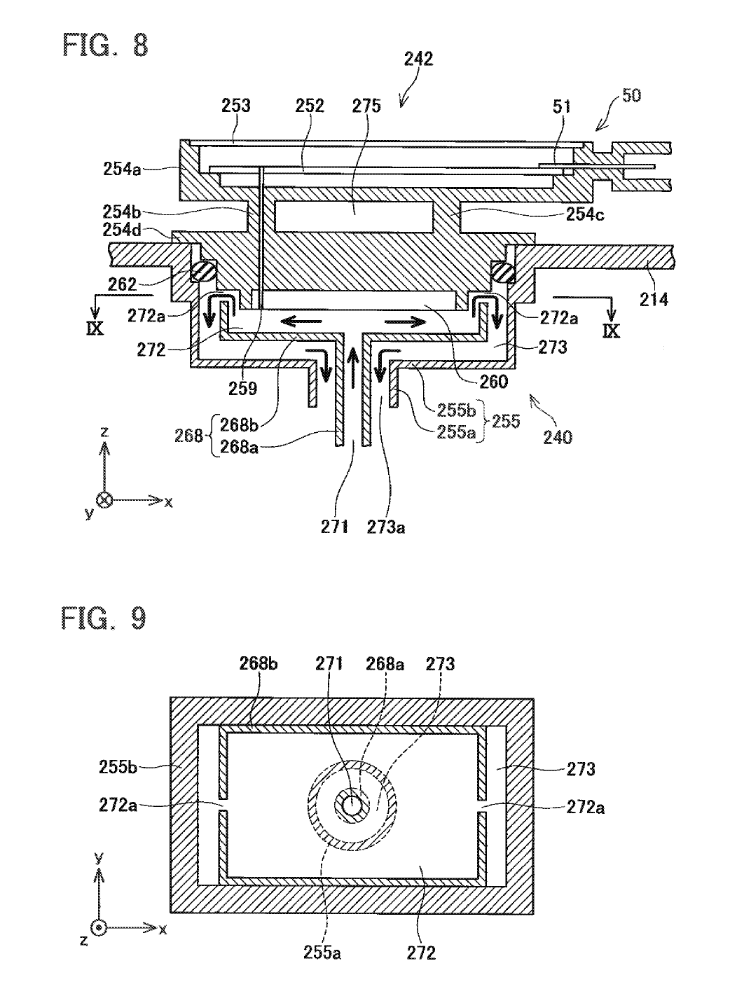

As shown in FIGS. 8 and 9, a first casing 240 includes an outer member 255, an inner member 268, and a lid 254d. A second casing 242 includes a lid 253, a housing 254a, and connecting portions 254b and 254c that connect the housing 254a and the lid 254d. The lower surface of the housing 254a and the upper surface of the lid 254d are separated, and an air passage 275 communicating with atmosphere is formed between the upper and lower surfaces. The air passage 275 is surrounded by the lower surface of the housing 254a, the upper surface of the lid 254d, and the connecting portions 254b and 254c. In FIG. 9, for better understanding of the configuration of the first casing 240, the lid 254d and the first electronic circuit 260 appearing on the IX-IX cross-section shown in FIG. 8 are not depicted.

The inner member 268 includes a pipe line 268a and a housing-shaped container 268b having a bottom surface. The upper end of the pipe line 268a is connected to the bottom surface of the container 268b and the lower end thereof is connected to the pipe line 34. The outer member 255 includes a pipe line 255a and a housing-shaped container 255b. The upper end of the container 255b is open. The container 268b is bonded to the container 255b in the y-axis direction shown in FIG. 8 and is bonded to the lid 254d in the positive (upward) z-axis direction. The container 268b is separated from the lid 264d in a passage 272a that is formed in a part of the upper portion of the container 268b. The upper end of the pipe line 255a is connected to the bottom surface of the container 255b. The pipe line 268a is disposed inside the pipe line 255a.

The flow path inside the pipe line 268a is the fuel supply passage 271. The inside of the outer member 255 is a fuel chamber and is partitioned into a circuit storage portion 272 and a fuel delivery portion 273 by the container 268b. The inside of the container 268b is the circuit storage portion 272, and the outside of the container 268b is the fuel delivery portion 273. The first electronic circuit 260 is stored in the first casing 240. The first electronic circuit 260 is fixed so that the planar direction thereof is parallel to the lower surface of the lid 254d, and the lower surface thereof is exposed to the inside of the circuit storage portion 272. The first electronic circuit 260 is a heat generating portion of a pump controller that operates the fuel pump 22. The second electronic circuit 252 is stored in the housing 254a of the second casing 242 and is sealed by the lid 253. The second electronic circuit 252 is a signal processing circuit of the pump controller similarly to the first embodiment and the like. The first and second electronic circuits 260 and 252 are electrically connected by a terminal 259 that extends from the second electronic circuit 252 and passes through the housing 254a, the connecting portion 254b, and the lid 254d.

The pipe line 255a is sufficiently shorter than the pipe line 268a, and the lower end of the pipe line 255a is open to the inside of the reserve cup 18 in the fuel tank 12 similarly to FIG. 1. The pipe line 268a is disposed in and near the outlet 273a, and the outlet 273a and a flow path near the outlet 273a are partitioned by the outer surface of the pipe line 268a and the inner surface of the pipe line 255a. That is, the outlet 273a is adjacent to the outside of the fuel supply passage 271.

The body 214 and the outer member 255 are integrally formed with resin. The housing 254a, the connecting portions 254b and 254c, the lid 254d, and the connector 50 are integrally formed with resin. The lid 254d is fitted to the inside of the outer member 255. The gap between the lid 254d and the outer member 255 is sealed by a sealant 262. The lid 254d is attached at an opening of the container 255b of the first casing 240. The upper end of the container 268b of the inner member 268 excluding a portion in which the passage 272a is formed is bonded to the lower surface of the lid 254d. Since the other configuration of the fuel supply device according to the third embodiment is the same as the first embodiment, description thereof will not be provided.

According to the third embodiment, the same operational effect as the first embodiment can be obtained. That is, since the first electronic circuit 260 is exposed to the inside of the circuit storage portion 272 of the fuel chamber and is in direct contact with fuel, the first electronic circuit 260 is efficiently cooled. Moreover, the outlet 273a is adjacent to the outer surface of the pipe line 268a that partitions the fuel supply passage 271. Thus, the fuel reliably returns into the reserve cup 18 in the fuel tank 12 along the outer surfaces of the pipe line 268a and the pipe line 34, and the generation of the sound of the fuel falling when the fuel is delivered can be suppressed. Further, since the first electronic circuit 260 is the heat generating portion of the pump controller, the pump controller is likely to generate heat. Since the first electronic circuit 260 that is likely to generate heat is in contact with the fuel, the first electronic circuit 260 can be efficiently cooled.

In the third embodiment, the air passage 275 communicating with atmosphere is formed between the upper surface of the lid 245d attached at the opening of the first casing 240 and the lower surface of the housing 254a of the second casing 242. Since the lid 245d is formed with resin, a concern may occur that fuel may permeate into the second casing 242 through the lid 254d from the inside of the first casing 240. According to the third embodiment, the air passage 275 is formed between the upper surface of the lid 245d and the lower surface of the housing 254a of the second casing 242. Thus, even when the fuel in the first casing 240 permeates through the lid 245d, the fuel diffuses into the atmosphere through the air passage 275, and the fuel is suppressed from further permeating into the second casing 242. That is, the fuel is suppressed from permeating into the second casing in which the second electronic circuit vulnerable to fuel is stored.

The air passage 275 may serve as an inserting portion in which a fixing member for fixing the second casing 242 and the body 214 is to be inserted. For example, an engagement portion that engages with the fixing member may be formed on a side of the connecting portions 254b and 254c closer to the air passage 275, the fixing member may be inserted in the air passage 275, and the engagement portion on the air passage 275 may be engaged with the engagement portion on the fixing member, whereby the second casing 242 and the body 214 are fixed.

### Fourth Embodiment

A fuel supply device according to a fourth embodiment is different from the fuel supply device according to the third embodiment in terms of the configuration of the first casing.

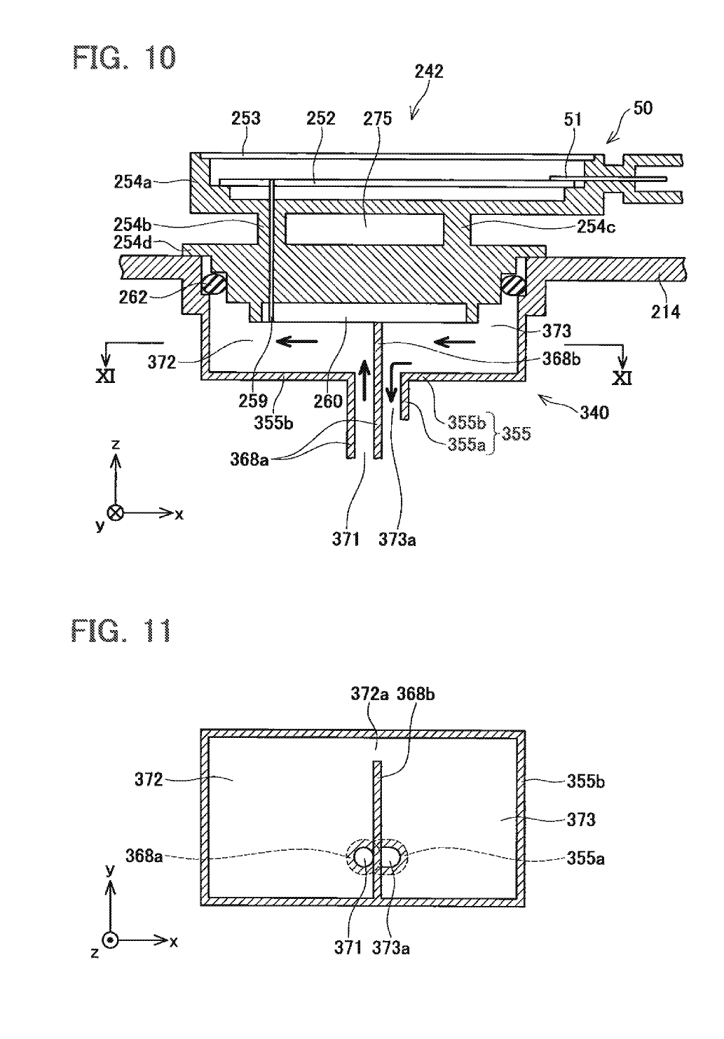

As shown in FIGS. 10 and 11, a first casing 340 includes an outer member 355, a pipe line 368a, and a planar portion 368b. The outer member 355 includes an approximately semi-circular pipe line 355a and a housing-shaped container 355b. The upper end of the container 355b is open. The semi-circular pipe line 355a is bonded to a side surface of the pipe line 368a on a side where the semi-circular pipe line 355a is chipped in an approximately semi-circular shape. The semi-circular pipe line 355a and the pipe line 368a have upper ends connected to the bottom surface of the container 355b and are disposed closer to the negative y-axis side than the center in the y-axis direction of the bottom surface. The lower end of the pipe line 368a is connected to the pipe line 34. The flow path inside the pipe line 368a is a fuel supply passage 371. The planar portion 368b is disposed at such a position that the planar portion 368b passes above the semi-circular pipe line 355a and the pipe line 368a and partitions the container 355b. The inside of the container 355b is a fuel chamber and is separated by the planar portion 368b into a circuit storage portion 372 connected to the pipe line 368a and a fuel delivery portion 373 connected to the semi-circular pipe line 355a. A passage 372a is formed near and above an end of the planar portion 368b in the positive y-axis direction, and the circuit storage portion 372 and the fuel delivery portion 373 communicate with each other through the passage 372a. The fuel delivery portion 373 is further connected to an outlet 373a that is at the lower end of the semi-circular pipe line 355a. The outlet 373a is open to the inside of the reserve cup 18 in the fuel tank 12 similarly to FIG. 1. The outlet 373a and the vicinity thereof are formed of the inner surface of the semi-circular pipe line 355a and a part of the outer surface of the pipe line 368a and are adjacent to a part of the outer surface of the fuel supply passage 371.

The body 214, the outer member 355, the pipe line 368a, and the planar portion 368b are integrally formed with resin. The housing 254a, the connecting portions 254b and 254c, the lid 254d, and the connector 50 are integrally formed with resin. Since the other configuration of the fuel supply device according to the fourth embodiment is the same as the third embodiment, description thereof will not be provided.

In the fourth embodiment, the same operational effect as the first embodiment can be obtained. That is, since the first electronic circuit 260 is exposed to the inside of the circuit storage portion 372 of the fuel chamber and is in direct contact with fuel, the first electronic circuit 260 is efficiently cooled. Moreover, the outlet 373a is adjacent to a part of the outer surface of the pipe line 368a that partitions the fuel supply passage 371. Thus, the fuel reliably returns into the reserve cup 18 in the fuel tank 12 along the outer surfaces of the pipe line 368a and the pipe line 34, and the generation of the sound of the fuel falling when the fuel is delivered can be suppressed.

Moreover, since the same air passage 275 as the third embodiment is formed, the fuel can be suppressed from permeating into the second casing 242 from the inside of the first casing 340. Further, since the first electronic circuit 260 is the heat generating portion of the pump controller, the pump controller is likely to generate heat. Since the first electronic circuit 260 that is likely to generate heat is in contact with the fuel, the first electronic circuit 260 can be efficiently cooled. Furthermore, the heat generated by the first electronic circuit can be prevented from being transmitted to the second electronic circuit.

### MODIFICATION

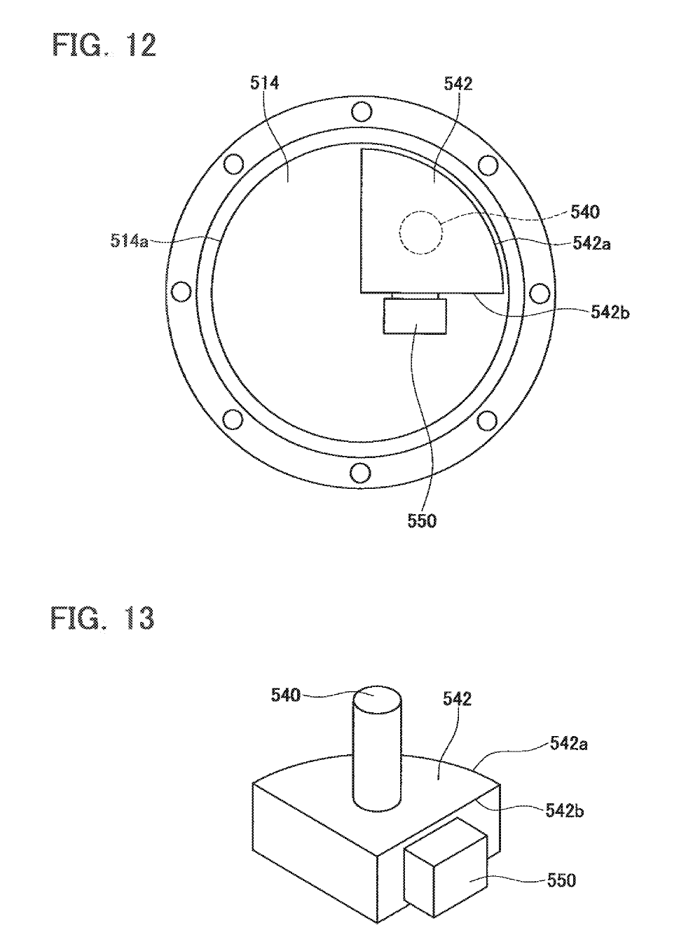

The second casing and the connector are preferably formed inside of the circumference of the body. For example, when the body is circular in a plan view, the upper and lower surfaces of the second casing may have the shape of a fan having an arc portion that follows the circumference of the body. As shown in FIGS. 12 and 13, the upper and lower surfaces of a second casing 542 are fan-shaped in a plan view, and an arc portion 542a of the second casing 542 follows a circumference 514a of a circular body 514. A first casing 540 extends from the fan-shaped lower surface of the second casing 542, and a connector 550 extends from a side surface that is connected to a straight line portion of the fan shape of the second casing 542. The second casing 542 may be disposed on the upper surface of the body 514 without protruding from the circumference of the body 514.

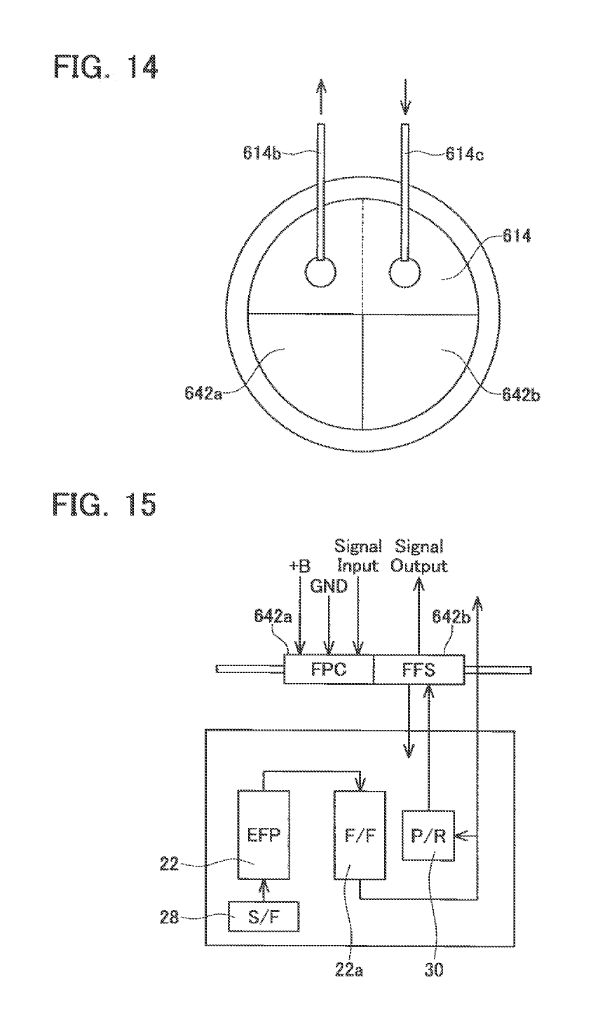

As shown in FIG. 14, two second casings 642a and 642b of which the upper and lower surfaces have a fan shape having a central angle of 90° may be disposed above a circular body 614 in a plan view. A second electronic circuit stored in the second casing 642a is a pump controller. A second electronic circuit stored in the second casing 642b is a capacitance fuel sensor. Moreover, the second casings 642a and 642b may be disposed adjacent to each other, and a fuel extracting pipe 614b and a fuel returning pipe 614c may be formed in an upper portion of the body 614 where the second casings 642a and 642b are not formed. As shown in FIG. 15, a pump controller (FPC) stored in the second casing 642a controls a fuel pump (EFP) in response to electrical signals from an external circuit (not shown). Moreover, a part of the fuel supplied from the fuel pump is supplied to the capacitance fuel sensor stored in the second casing 642b, and electrical signals that indicate the measured fuel quality are output to the external circuit (not shown). The external circuit outputs signals for controlling the pump controller based on various types of information that indicate an engine operation state. Since constituent elements in FIG. 15 denoted by the same reference numerals as FIG. 1 represent the same configuration as FIG. 1, description thereof will not be provided.

What is claimed is:

1. A fuel supply device comprising:
a set plate closing an opening of a fuel tank;
a housing disposed on an opposite side of the fuel tank with respect to the set plate and storing an electric circuit; and
a connector disposed on the opposite side of fuel tank with respect to the set plate disposed between the set plate and the housing, and connecting the set plate and the housing,
wherein
an air passage is disposed between the set plate and the housing and communicates with atmosphere, and
the set plate, the housing and the connector are provided integrally.

2. The fuel supply device of claim 1, wherein
the set plate comprises:
a body having an opening and closing the opening of the fuel tank; and
a lid closing the opening of the body, and
the lid, the housing and the connector are provided integrally.

3. The fuel supply device of claim 2, further comprising
a terminal extending from the electric circuit, piercing the housing, the connector and the lid and reaching a fuel tank side of the lid.

4. The fuel supply device of claim 3, wherein
a part of the terminal between the set plate and the housing is covered by the connector.
